(19) United States
(12) Patent Application Publication
(10) Pub. No.: US 2007/0237900 A1
(43) Pub. Date: Oct. 11, 2007

(54) Controlling surface characteristics of an image forming device component

(76) Inventor: James Semler, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/400,625

(22) Filed: Apr. 7, 2006

(51) Int. Cl. B05D 3/10; B05D 3/12; B05D 3/02; B05D 3/00

(52) U.S. Cl. 427/337; 427/355; 427/372.2; 427/374.1; 427/398.1

(57) ABSTRACT

The present invention relates to controlling the surface characteristics of an image forming device component. The device may include photoconductive elements or non-photoconductive elements such as rollers or blades. The surface characteristics such as texture may be controlled by introducing a coating to the surface of a component or modifying the mechanical properties of the component surface while in a physically stressed state. This may then be followed by release of such stress and development of strain at the component surface.

### FIELD OF INVENTION

The present invention relates to a method of controlling surface characteristics on an image forming device component. The image forming device may be, for example, an electrophotographic printer, an inkjet printer, a fax device, a copier, an all-in-one device or a multipurpose device.

### BACKGROUND

Many components used in image forming apparatus may benefit from a textured coating surface. These benefits may include modification of electrical, physical and chemical properties such as resistivity, roughness, or surface energy. The components upon which the coatings may be applied may include photo-conductive devices and non-photoconductive devices such as developer rollers, doctor blades, etc.

### SUMMARY

In an exemplary embodiment, the present invention relates to a process for coating a component for use in an image forming apparatus which may then induce a surface finish. The process may include application of a coating to a component, the component having a first surface area A₁ and altering the surface area of the component to provide a second surface area A₂ where A₂≠A₁. The coating may have a modulus E₁ and the component may have a modulus E₂, where E₁>E₂.

In another exemplary embodiment the present invention relates to a process for modifying the surface of a component for use in an image forming apparatus, the component having a surface and a corresponding surface area. The process may then include modifying the surface of the component to develop a surface modulus E₁, where the component has a modulus E₂, wherein E₁>E₂. This may then be followed by altering (e.g. reducing) the surface area of the component which may then increase surface roughness such as a mean peak-to-valley height, Rz.

### BRIEF DESCRIPTION OF DRAWINGS

The detailed description below may be better understood with reference to the accompanying figures which are provided for illustrative purposes and are not to be considered as limiting any aspect of the invention.

FIG. 1 provides an illustration of an exemplary coating process to develop surface characteristics on an image forming component.

FIG. 2 provides an illustration of an exemplary process of modifying surface characteristics (e.g. increasing surface modulus) directly on an image forming component.

FIG. 3 provides a graph of Ra (average roughness) and Rz (mean peak-to-valley height) as a function of delay time between coating and UV treatment.

FIG. 4 provides an illustration of an exemplary process as applied to a roller for use in an image forming apparatus.

### DETAILED DESCRIPTION

The present invention relates to a method of controlling surface characteristics of an image forming device component. The surface characteristics may be altered by coating or by modifying the mechanical properties of the surface, when under tension, by methods such as exposure to energy sources such UV radiation, plasma, heat, chemical modifiers, etc. Accordingly, the coating or step of surface modification may be carried out when the surface of the component is in a stressed configuration. Such stressed state may include an increase in surface area or volume, followed by a release of stress wherein the component may return completely, or even partially, to its original dimensions.

The image forming device component may then be advantageously employed in an electrophotographic printer, an inkjet printer, a fax device, a copier, an all-in-one device or a multipurpose device. The component may also be utilized in a printer cartridge, such as a toner cartridge. The component surface characteristics which may be controlled may include surface texture. Such texture may be specifically monitored by parameter values such as average overall roughness (Ra) and mean peak-to-valley height (Rz).

The component may be formed from a variety of polymeric materials including both thermoplastic and thermoset (crosslinked) materials. The component may be specifically formed from elastomeric material (materials which may recover substantially from an applied stress) such as diene rubber materials, synthetic rubber (SBR), natural rubber (polyisoprenes) and specialty types elastomers. For example, the rubbers may include silicone rubber and/or epichlorohydrin rubber, etc. The materials may be relatively compliant exhibiting a Shore A durometer of less than or equal to about 50, including all increments and values therein, such as 40, 30, etc. The materials therefore may be cellular or foam-based type resins. In all cases, the polymeric materials may also include additives to adjust other bulk properties, such as electrical conductivity. Accordingly, the component may amount to, e.g., a developer roller suitable for use in an electrophotographic printer that relies upon the use of a conductive elastomeric core and a resistive type coating.

To develop a stress in the component, the physical dimensions of the component may be altered. For example, the volume “V” of the component may be altered prior to or during a selected surface modification procedure. The volume may therefore be increased or decreased through the application of solvents, exposure to mechanical stress, including stretching or even vacuum application, or due to thermal expansion by the application of heat. For example, the component may be volumetrically increased or decreased by about 1-500%, including all ranges and values therein, including 100%, 200%, etc. Expansion or contraction may be isotropic or anisotropic.

A stress may also be introduced into the component wherein the surface area “A” of the component is altered. Such surface area alteration may similarly take place prior to or during a given surface modification procedure. This option may therefore apply even if the component volume itself is not substantially altered. Illustrative of such a situation may be where a substrate is stretched or compressed and the volume change is relatively minor (e.g., less than or equal to about 5.0%). The component surface area may therefore be selectively increased or decreased by about 1-500%, including all ranges and values therein, including 100%, 200%, etc. The surface area alteration may be isotropic or anisotropic.

Once altered and stressed, the component may return to about its initial volume or surface area or within about 0.01% to about 10.00% of an initial volume or surface area, including all increments and ranges therein. For example, where the component has been exposed to a solvent, which causes a volume or surface area change, the solvent may be allowed to evaporate. Alternatively, where the component has been exposed to a mechanical or thermal stress, the component may be allowed to relax or substantially return to an unstressed state or initial temperature.

The coatings herein may also be understood as coatings that include a chemical compound which may increase in viscosity and/or molecular weight though a polymerization and/or crosslinking type reaction. The chemical may therefore include monomers and/or oligomers which may react (cure) and undergo polymerization to form a solid. Such monomers or oligomers may also have one or a plurality of functional groups to allow for higher polymerization rates, high relative amounts of branching, and/or higher relative degrees of crosslinking. Initiation and/or curing may be triggered by variable or mixed energy sources such as heat curing, UV radiation, catalysts. Initiation or curing may also be developed by addition of one or more co-reactants, etc. Accordingly, the coatings as applied may have an initial viscosity of about 0.5 to 100,000 centipoise, including all values and increments therebetween, and undergo reaction and solidification upon the component surface.

The coating may include up to 100% (wt.) reactive chemical (e.g. monomer) and may also include solvents, such as an organic solvent or even water. The coating may also include up to 100% (wt.) formed polymer resin, or polymer resin within a solvent, such that upon solvent evaporation, the resin remains as the coating material. For example, the coating may include a polyurethane type polymer dissolved in a solvent, such as an organic solvent. In either case it may be appreciated that the solvents utilized in the coating may be such that they also serve to alter the volume or surface area of the component to which they may be applied. Accordingly, the solvents used herein may be selected such that they serve to partially dissolve and reversibly swell or reversibly increase the volume of, e.g., an underlying polymeric or crosslinked material. In that regard, one may select a solvent that provides a solubility parameter (δ₁) measured in (cal/cm³)^{0.5} that is within about +/−5.0 units of the solubility parameter (δ₂) of the component to be coated, including all values and/or increments therein, such as within +/− 1-2 units, +/−0.25-1 units, etc.

The coatings may also contain fillers which may affect initial component (e.g. monomer) viscosity as well as viscosity build-up prior to gel or solidification. In addition the fillers may also influence ultimate texture at the surface of the cured resin. Fillers may include particulate, metallic, ceramic, ionic or even polymeric type materials. Fillers may also influence the final bulk properties of the coating, such as electrical conductivity, as noted above.

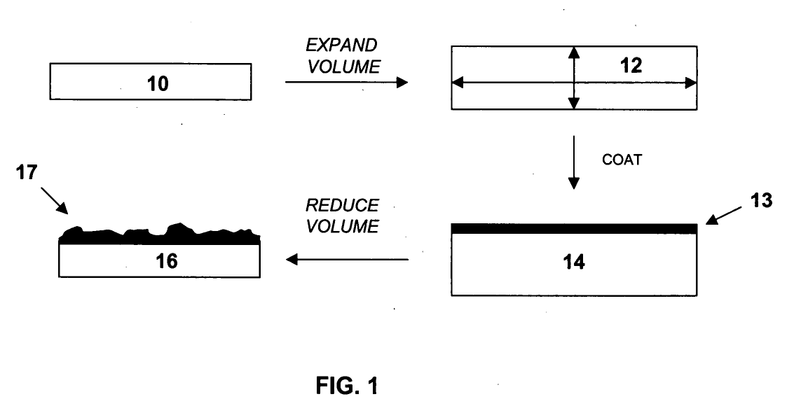

As illustrated in FIG. 1, a component 10 may be supplied, which may be stressed and expanded in surface area or volume as shown generally at 12. A coating 13 may be applied to provide coated component 14. As noted above, the coating may be one that contains monomers and/or oligomers that react and polymerize on the component surface. In addition, the coating may contain a preformed resin which remains after solvent removal. In either situation the coating may be selected so as to provide a modulus value that is higher than the modulus of those materials employed to form the component 10. Accordingly, the modulus E₁ of coating layer 17 as ultimately formed on the surface of component 16 (which represents component 10 after return to its unstressed configuration) may assume a higher value than the modulus E₂ of those materials that are employed to form component 10. The modulus E may be understood herein as the relationship between stress and strain of the selected material. Such stress may include, e.g., a tensile stress or compressive stress. When the modulus E is relatively large, the material may more strongly resist deformation (strain) and when the modulus E is relatively lower, the material may demonstrate less resistance to deformation. The modulus of layer 17 may therefore be about 1.0-100% greater than the modulus of the material used to form component 10, including all values and increments therein.

Returning then to a description of the coating process illustrated in FIG. 1, when the volume or coated surface area 13 of the component is reduced (14→16) the coating material may tend to buckle and lead to the formation of surface irregularities or surface texture 17. Accordingly, it may be appreciated that the amount of initial volume expansion may be proportional to the level of surface irregularity that may ultimately be obtained. In addition, it can be appreciated that the modulus value of the entire coating, or the modulus of the coating surface, after exposure to a given energy source, may be utilized to influence the amount and type of texture 17 that is developed.

It should also be appreciated that the coating herein may be physically applied to component 14 by, for example, spray coating, dip coating, gravure coating, etc. The coating may also be applied to the substrate between about 1 to 150 microns in thickness, including all increments and values therein, such as 10 microns, 20 microns, etc. The coating may be reacted prior to, during or after application of the coating to the surface of the component 14. In addition, a delay may be present between the application of the coating to the component and reacting the coating. For example, a delay in the range of about 1 minute to about 6 hours, including all increments and ranges therein, may occur between the application and initiation of curing of the coating. Furthermore, the coating may be reacted prior to, during or after alteration of the volume or surface area of the substrate. It should also be appreciated that only the exposed surface or a portion of the surface of the coating may be reacted. For example, the surface may be reacted (cured) to between about 1-50% of the coating depth, including all values and increments therein, such as 10%, 20%, etc.

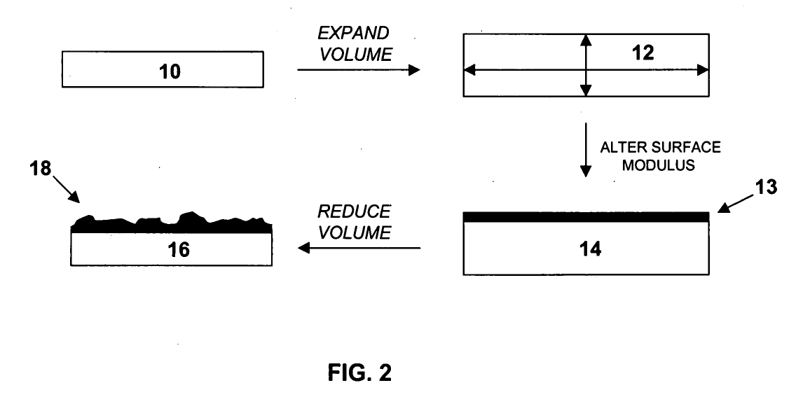

Attention is now directed to FIG. 2. In this exemplary embodiment, the component 10, which may be similarly formed from a polymeric type material, may still undergo a given stress and experience an increase in surface area or volume as shown generally at 12. At this point, the surface of the stressed component may be exposed to a selected energy source or combination of energy sources, such as UV radiation, visible light, electron beam or plasma treatment. The surface may also be exposed to chemical modifiers. Upon exposure, e.g. to UV light, the surface region of the polymeric material may undergo a number of reactions that may include, e.g. a crosslinking type of reaction. This may then lead to a localized increased in rigidity or modulus as compared to those portions of the component that are not so exposed. In such a case, upon release of stress and reduction in volume and surface area (14→16) an integral surface 18 may be developed that provides a desired texture.

Texture may be understood herein as the provision of relatively short range or long range features formed in the surface of the coating. For example, texture may include projections from or depressions into the coating surface. The texture may be regular or irregular across a selected component surface area. It should therefore be appreciated that the degree of texture provided may depend upon the change in the volume or surface area of the substrate, the delay between application of the coating and reaction of the coating, the depth in which the coating is cured, etc. As noted above, texture may be monitored by consideration of parameters such as average roughness (Ra) and mean peak-to-valley height (Rz) and the present invention therefore may provide a method to control such variables over a relatively wide range. Ra may be calculated by an algorithm that measures the average length between the peaks and valleys and the deviation from the mean line on the entire surface within the sampling length. Ra averages all peaks and valleys of the roughness profile and then neutralizes the few outlying points so that the extreme points have less significant impact on the final results. Rz may be calculated by measuring the vertical distance from the highest peak to the lowest valley within five sampling lengths, then averaging these distances. Rz averages only the five highest peaks and the five deepest valleys. Typical scans are conducted over 4.8 mm utilizing a cutoff wavelength of 0.8 mm for a Gaussian filter as given by ISO Standard 11562:1996.

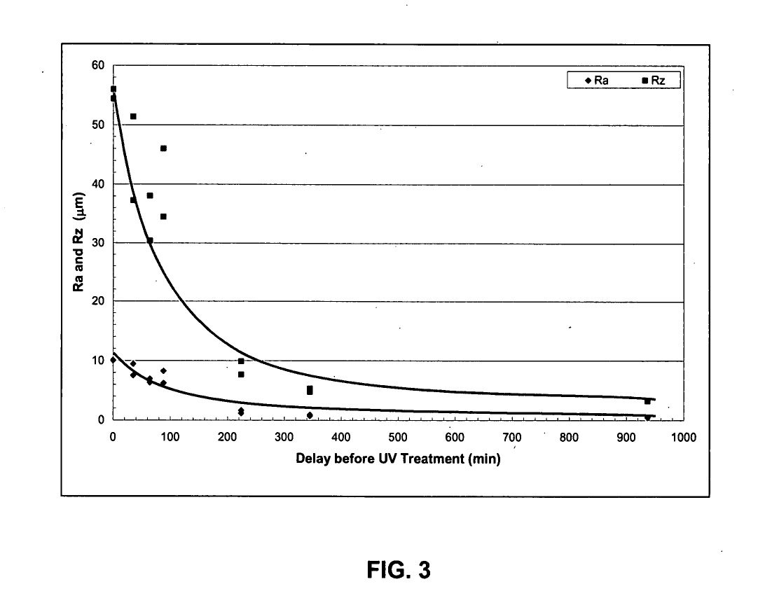

FIG. 3 presents a graph of Ra (average roughness) and Rz (mean peak-to-valley height) as a function of delay time between solvent coating of a component and UV treatment. As noted above, upon exposure to solvent, the component may expand and as the delay time before UV treatment increases, and solvent is allowed to evaporate, the strain induced on the formed coating due to shrinkage may decrease. This then may reduce the values of Ra and Rz. It should be noted that the lines in FIG. 3 are not intended to identify a mathematical fit, but to demonstrate that the values of Ra and Rz herein can be controlled to provide a desired degree of texture.

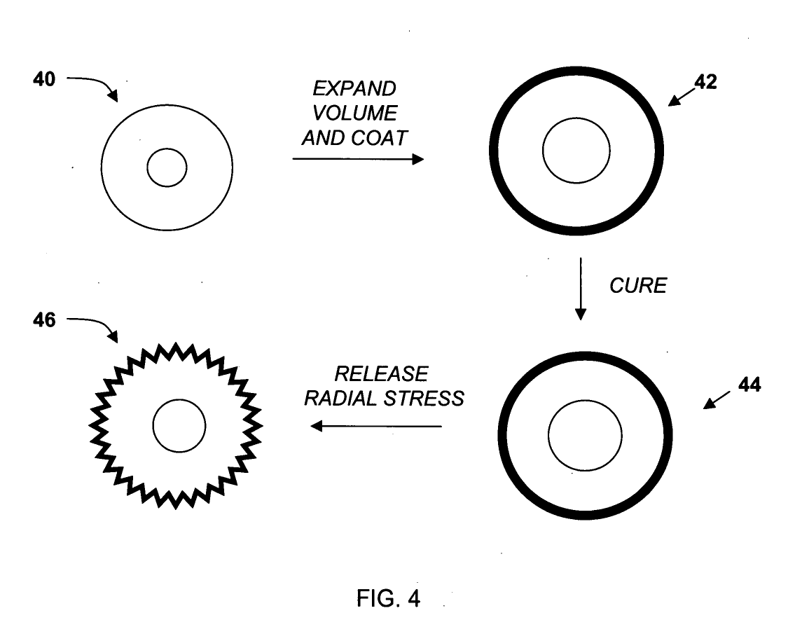

FIG. 4 illustrates an exemplary embodiment wherein the surface texture of a component, such as a roller for use in an image forming device, may be processed to provide a desired degree of roughness. The roller 40 as supplied may be formed from an elastomeric/rubber material and expanded in surface area or volume according to any one of the above referenced procedures. Accordingly, a coating may be applied as illustrated generally at 42 (e.g. a polyurethane type coating) that contains a solvent that diffuses within and expands the volume of the underlying elastomeric resin. One may then place the roller in an environmental chamber to allow the coating to cure (in the case of a reactive type system) and/or for the solvent to evaporate. In addition, one may optionally expose the roller to an energy source, such as UV radiation, to accelerate the curing of any applicable coating reaction and/or to cure more so at the surface than at some underlying region of the coating. The cured roller 44 may then reach a point where the underlying elastomeric resin returns partially or substantially to its original surface area or volume at which point it may substantially release any remaining stress. A strain may then be developed on the coating which results in the formation of a textured surface shown generally at 46.

It can be appreciated that although the textured surface is illustrated as being generally uniform about the surface of the roller, the textured surface may also be non-uniform in its surface roughness. Again, surface features may be characterized by the parameters of Ra and Rz noted above. Along such lines, mean peak-to-valley height as developed herein may be greater than about 0.01 microns, and on the order of about 0.01-500 microns, including all values and increments therein. For example, the value of Rz may be greater than about 1.0 micron. In addition, it should now be appreciated that in lieu of a coating step, the roller surface may be exposed to an energy source such that the resin surface is crosslinked, thereby increasing the values of modulus at or within a given surface layer, and upon release of the radial stress, a texture may similarly be developed which may similarly have the aforementioned values of Rz.

The foregoing description is provided to illustrate and explain the present invention. However, the description hereinabove should not be considered to limit the scope of the invention set forth in the claims appended here to.

What is claimed is:

1. A process for coating a component for use in an image forming apparatus comprising:
applying a coating to a component, said component having a first surface area A₁ and altering said surface area of said component to provide a second surface area A₂ where A₂≠A₁.

2. The process of claim 1 wherein A₂<A₁.

3. The process of claim 1 wherein A₂>A₁.

4. The process of claim 1 wherein said coating has a first mean peak-to-valley height Rz₁ as applied and a second mean peak-to-valley height RZ₂ after said component surface area is altered wherein RZ₂>Rz₁.

5. The process of claim 4 wherein RZ₂ is greater than or equal to about 1 micron.

6. The process of claim 1 wherein said step of altering said surface area comprises exposing said component to a solvent wherein said solvent alters said component surface area.

7. The process of claim 6 wherein said coating solvent has a solubility parameter δ₁ and said component has a solubility parameter δ₂ and said solubility parameters are within about +/−5.0 units of one another.

8. The process of claim 1 wherein said step of altering said surface area comprises heating or cooling said component.

9. The process of claim 1 wherein said step of altering said surface area comprises mechanically expanding or compressing said component.

10. The process of claim 1 wherein said coating includes a reactive chemical having a molecular weight and reacting said chemical and increasing said molecular weight.

11. The process of claim 10 wherein said step of reacting said chemical occurs prior to or during the step of altering said component surface area.

12. The process of claim 10 wherein said coating has a surface and said reactive chemical undergoes a reaction at said surface.

13. The process of claim 1 wherein said coating has a modulus E₁ and said component has a modulus E₂, wherein E₁>E₂.

14. The process of claim 1 wherein said component, prior to coating, has a Shore A durometer of less than or equal to about 50.

15. The process of claim 1 wherein said component has a first volume V₁ and wherein the step of altering said surface area further comprises altering said first volume of said component to provide a second volume V₂ where V₂≠V₁.

16. A process for modifying the surface of a component for use in an image forming apparatus, the component having a surface and a surface area, comprising:
modifying the surface of said component wherein said modified surface has a modulus E₁ and said component has a modulus E₂, wherein E₁>E₂; and
altering the surface area of said component.

17. The process of claim 16 wherein said component has a first surface area A₁ and wherein said step of altering said surface area comprises providing a second surface area A₂ wherein A₂<A₁.

18. The process of claim 16 wherein said component has a first surface area A₁ and wherein said step of altering said surface area comprises providing a second surface area A₂ wherein A₂>A₁

19. The process of claim 16 wherein said surface has a first mean peak-to-valley surface roughness Rz₁ prior to altering said surface area and a second mean peak-to-valley surface roughness RZ₂ after altering said surface area wherein RZ₂>Rz₁.

20. The process of claim 16 wherein said step of modifying comprises exposing said surface to an energy source.

21. The process of claim 16 wherein said component has a Shore A durometer, prior to modifying, of less than or equal to about 50.

22. The process of claim 16 wherein said component has a first volume V₁ and said step of altering said surface area comprises altering said first volume of said component to provide a second volume V₂ where V₂≠V₁.
